(19) United States
(12) Patent Application Publication
(10) Pub. No.: US 2006/0101984 A1
(43) Pub. Date: May 18, 2006

(54) Training system

(76) Inventors: Akihiko Ikawa, Tokyo (JP); Yoshinori Shabana, Sagamihara-shi (JP)

Correspondence Address: INTELLECTUAL PROPERTY / TECHNOLOGY LAW, PO BOX 14329, RESEARCH TRIANGLE PARK, NC, 27709, US

(21) Appl. No.: 10/523,914

(22) PCT Filed: Aug. 8, 2003
(86) PCT No.: PCT/JP03/10175

§ 371 Date: Oct. 17, 2005

(30) Foreign Application Priority Data
Aug. 8, 2002 (JP) 2002-231838

(51) Int. Cl. G10H 7/00; A63H 5/00; G04B 13/00

(52) U.S. Cl. 84/609

(57) ABSTRACT

The present invention is a training system comprising a user terminal for executing training for user skill acquisition by using music data of an original work; a trainer terminal for generating training information for user skill acquisition; and a server for carrying out communications with the user terminal and the trainer terminal via a network, wherein the trainer terminal generates training information related to music data of an original work based on instructions from a trainer, and sends it to the server, the server distributes the received training information to the user terminal, and the user terminal repeatedly plays back the original work music data based on the distributed training information.

### CROSS-REFERENCES

The present invention relates to a method for supporting the learning of musical compositions and other original works, and a system for realizing this method.

### BACKGROUND

Today, music and other original works are recorded as music data on recording media such as CD-ROM (hereinafter referred to as “CD”) and sold the world over. If a user has a CD player or other such playback system or a computer equipped with multimedia functions, he can enjoy music from all over the world just by purchasing the desired CDs.

In addition, large numbers of these users not only enjoy listening to music, but also sing original works as karaoke songs and form bands to perform these songs. These users practice while listening to the songs on playback systems, and more particularly, they often practice by using the rewind function to repeatedly play back parts of a song.

Further, when a user wishes to improve his singing capabilities or performing skills, he can also receive specialized educational services. For example, there are lessons given by specialized schools and individual instructors. In the lessons, there are also times when original works are used as teaching materials. In this case, since a user can practice a song while receiving advice from a trainer, who possesses specialized knowledge, he not only effectively learns an original work, but can also enhance his own singing capabilities and performing skills.

Accordingly, as described hereinabove, when a user attempts to learn an original work or when a user attempts to learn a desired skill through an original work, most often he practices while repeatedly playing back a song in parts using the rewind function of the playback system. However, operating the playback system or computer while singing or performing a song is difficult and complicated work, and as a result of this, the user is apt to be unable to concentrate on his practice. Further, when a user with poor singing abilities or performing skills suddenly tries to learn an original work, most often he is not able to learn it the way he had hoped due to a lack of talent. Conversely, even if a very experienced user is able to learn an original work to the best of his ability, the truth is that he is still not able to determine his level of learning, and is not likely to detect his own shortcomings and faults.

Accordingly, in order to solve for the problems inherent in learning at the individual level, methods for receiving lessons from specialized schools or individual instructors as described hereinabove have also been proposed. However, lessons by specialized schools or individual instructors as described hereinabove are generally expensive, making them problematic from the standpoint of cost. Further, users must go to the trouble of traveling to a school or classroom, giving rise to physical and time-related problems.

Thus, the problems with a user purchasing an original work to learn it on his own is that, although he can study informally and inexpensively in his own home, the playback task that accompanies learning is troublesome, and he is limited by his own capabilities. By contrast, although a user can expect effective learning by taking lessons from an expert, this gives rise to the problems of costs and time.

Furthermore, at specialized educational service providers, trainers, who possesses the expert knowledge, provides training to enable users to acquire musical and other skills. However, for educational services such as these, the training venue and time are liable to be limited so that the trainer and user can proceed ahead with face-to-face training. For this reason, methods such as distance learning can also be considered, but an effective distance learning method that is capable of providing training, which enables a user to acquire a desired skill through the medium of an original work, and which is closely tailored to an individual user's desires and level of ability has yet to be proposed.

Accordingly, a first object of the present invention is to provide a scheme, which either enables a user, who has purchased an original work, to effectively learn this original work, or enables a user to effectively acquire a desired skill through the medium of an original work.

Further, a second object of the present invention is to provide a scheme for enabling a provider, who provides musical and other educational services, to provide a training method that makes use of original works and does not limit the training venue and time.

### SUMMARY

The present invention is a training system comprising a user terminal for executing training for user skill acquisition using targeted data of an original work, a trainer terminal for generating training information for user skill acquisition, and a server for carrying out communications with a user terminal and a trainer terminal via a network, the above-mentioned trainer terminal comprising generating means for generating, based on a command from a trainer, training information related to the targeted data of an original work, and transmitting means for transmitting generated training information to the server, the above-mentioned server comprising distributing means for distributing received training information to a user terminal, and the above-mentioned user terminal comprising playback means for repeatedly playing back the targeted data of an original work based on distributed training information.

Furthermore, the targeted data is determined according to the contents of an original work, and when the original work is music, corresponds to music data.

Further, it is preferable that a user terminal comprise not only a playback function, but also, as needed, a display function, an audio recording function, a comparative playback function and an evaluation function. A user terminal will be able to implement more effective training using these functions.

It is preferable that the above-mentioned generated training information comprise break information for showing optional breaks in the targeted data, and that the above-mentioned user terminal playback means repeatedly play back the targeted data on the basis of the break information included in the distributed training information.

It is preferable that the above-mentioned generated training information comprise a control program for controlling the playback of the targeted data based on the break information, and that the above-mentioned user terminal playback means reference the break information in accordance with the control program included in the distributed training information, specify a playback part within the targeted data and repeatedly play back the specified part. This makes it possible to skip a part that is not required for a user's training and to repeat as needed a part that is required.

It is preferable that the above-mentioned generated training information comprise additional information to be played back in association with the targeted data, and that the above-mentioned user terminal further comprise outputting means for outputting the additional information in association with the targeted data in accordance with the control program included in the distributed training information.

It is preferable that the above-mentioned server further comprise billing/payment means for executing billing to a user and payment to a trainer in accordance with the distribution status of the training information.

Further, it is preferable that the above-mentioned generated training information comprise characteristic information of the above-mentioned music data, which is extracted in accordance with a predetermined extraction condition from music data corresponding to the training information, and that the above-mentioned user terminal further comprise determination means for extracting, in accordance with the above-mentioned extraction condition, music data characteristic information from music data targeted for playback, and for determining whether or not this extracted characteristic information coincides with characteristic information included in the above-mentioned distributed training information.

Further, the present invention is a training method for a training system comprising a user terminal for executing training for user skill acquisition using targeted data of an original work, a trainer terminal for generating training information for user skill acquisition, and a server for carrying out communications with a user terminal and a trainer terminal via a network, this training method being characterized in that the above-mentioned trainer terminal generates, based on a command from a trainer, training information related to the targeted data of an original work, and transmits this generated training information to the server, the above-mentioned server distributes received training information to a user terminal, and the above-mentioned user terminal repeatedly plays back the targeted data of an original work based on distributed training information.

Further, the above invention also comprises a program for achieving prescribed functions in a computer, and a recording medium in which this program is recorded. Further, means in this specification can be realized by hardware, software or a combination of hardware and software. Implementation by a combination of hardware and software, for example, corresponds to implementation in a computer system having a prescribed program. Also, a function possessed by one means can be realized by two or more pieces of hardware, software, or combinations of hardware and software, and the functions of two or more means can be realized by one piece of hardware, software, or a combination of hardware and software.

### DESCRIPTION OF DRAWINGS

FIG. 1 is a diagram representing an overview of a training system for realizing a scheme related to the present invention;

FIG. 2 is a block diagram representing the constitution of a server;

FIG. 3 is a block diagram representing the constitution of a user terminal;

FIG. 4 is a block diagram representing the constitution of a trainer terminal;

FIG. 5 is a diagram showing an example of data structures of databases;

FIG. 6 is a diagram representing examples of break information that has been set;

FIG. 7 is a diagram showing an example of a break information table;

FIG. 8 is a diagram showing an example of a control program;

FIG. 9 is a flowchart showing the flow of training information generation processing;

FIG. 10 is a flowchart showing the flow of training information registration processing;

FIG. 11 is a flowchart showing the flow of training information reception processing;

FIG. 12 is a flowchart showing the flow of training information distribution processing;

FIG. 13 is a diagram showing an example of the data configuration of training information transmitted by the server 10;

FIG. 14 is a flowchart showing training information-based music data playback processing;

FIG. 15 is a diagram representing examples of training information search screens displayed on the screen of a user terminal 20;

FIG. 16 is a diagram showing an example of a training start screen displayed on the screen of a terminal 20;

FIG. 17 is a diagram showing an example of a training execution screen displayed on the screen of a terminal 20;

FIG. 18 is a diagram showing an example of a user profile registration screen displayed on the screen of a terminal 20;

FIG. 19 is a diagram representing an overview of the configuration of a scheme related to a second embodiment; and

FIG. 20 is a flowchart showing music data playback processing related to a third embodiment.

Furthermore, in the figures, reference numeral 10 refers to a training distribution server, 20 to a user terminal, 30 to a trainer terminal, 40 to the Internet, and 50 to a recording medium (music data).

### DETAILD DESCRIPTION

Next, the embodiments of the present invention will be explained while referring to the figures.

### FIRST EMBODIMENT

A first embodiment is characterized in that training information related to an original work (break information, control program, additional information) prepared by a trainer possessing specialized knowledge is distributed over the Internet to a user, who has purchased the original work. Since the user can repeatedly play back the original work using the training information prepared by the trainer, it becomes possible for the user to more effectively learn the original work, and to more effectively acquire a desired skill through the original work.

### ORIGINAL WORK

The term original work typically refers to a work of art, such as music or images that are protected by the Copyright Act. In this embodiment, the explanation is given for a case in which the original work is a song. However, the present invention is not limited to this, and as long as the original work is one that is well suited to training based on repeated playback, the present invention can arbitrarily be applied to this work. For example, the present invention can also be applied to language learning, movies, recitation, a musician, and comic dialogue. Furthermore, in addition to music information, an original work (targeted data) can also comprise moving-picture and still-picture information, the types of information being determined by the content of the original work and the type of medium. Further, in this embodiment, an original work is recorded in a file format, such as MP3, MPEG or the like, but the data format is not limited to these formats.

### OVERVIEW OF SCHEME

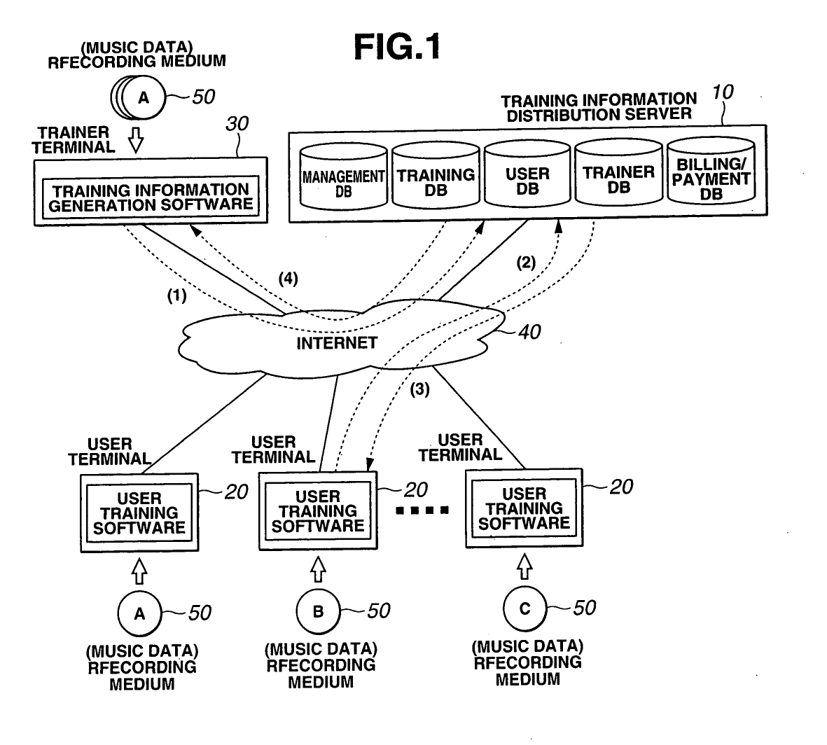

Next, an overview of a scheme related to the present invention will be explained. FIG. 1 is a diagram representing an overview of a training system (hereinafter called the “system”) for realizing a scheme related to the present invention. The system is configured by establishing communications links between a server 10 for distributing training information, user terminals 20 and a trainer terminal 30 via a network 40, such as the Internet.

The server 10 communicates with the user terminals 20, and distributes training information related to an original work to the user terminals 20. It also communicates with the trainer terminal 30, and receives and registers trainer-prepared training information. Further, the server 10 comprises a management DB (database), a training DB, a user DB, a trainer DB and a billing/payment DB. The management DB is for managing an original work and training information, and stores an original work and training information correspondently. The training DB is for storing training information, and stores break information, a control program and additional information and the like. The user DB is for managing user-related information, and stores a user's personal data, billing information, and training history information and the like. The trainer DB is for managing trainer-related information, and stores a trainer's personal data, and prepared training information and the like. Further, the billing/payment DB is for calculating and managing the amount billed to a user and the amount paid to a trainer. The data structures for these DB will be explained hereinbelow.

A user terminal 20 communicates with the server 10, and receives training information related to an original work. The terminal 20 reads music data from a prescribed recording medium 50, and stores it in a prescribed storage area in an MP3 or other file format. User training software (hereinafter referred to as the “training software”) is installed on the terminal 20. The training software comprises a playback function for playing back, on the basis of training information, music data stored in a prescribed storage area. Further, the training software also comprises a display function for displaying a musical score, which is additional information, an audio recording function for recording a user's voice and musical performance, an evaluation function for evaluating recorded audio information, and a management function for managing the progress of a user in accordance with his level of proficiency.

The trainer terminal 30 communicates with the server 10, and transmits trainer-prepared training information. Further, the terminal 30 reads music data from a prescribed recording medium 50, and stores it in a prescribed storage area in an MP3 or other file format. Training information generation software is installed on the terminal 30. Training information generation software comprises a setup function for setting up training information corresponding to an original work, that is, song identification information for identifying music data, break information and a control program, as well as additional information.

Next, an overview of the operation of a system configured as described hereinabove will be explained. Furthermore, a case in which a user purchases a music CD, and attempts to master a song A of the music CD will be given as an example in the explanation provided herein.

First, a trainer generates training information (song identification information, break information, control program, additional information and so forth) for the song A using training information generation software. Training information can be arbitrarily prepared by a trainer. Using the training information generation software, first a trainer sets the break information. Break information is information for repeatedly playing back the song A, and is a separator for dividing the song A into arbitrary segments. The song A is repeatedly played back in units (break units) separated by the break information. It is supposed here that the break information has been set according to the fundamental units of the song. More specifically, it is supposed that break information is set at each of six fundamental units, “Intro (break information 1)”→“First Verse (break information 2)”→“Second Verse (break information 3)”→“Third Verse (break information 4)”→“Fourth Verse (break information 5)”→“Ending (break information 6).”

Next, the trainer sets the additional information. Additional information is information that is played back and displayed together with the song A for effective learning. Additional information is optional information that a trainer can set arbitrarily. For example, it corresponds to the lyrics (text), musical score (images) and lesson information (voice).

Finally, the trainer sets the control program. The control program is a program for controlling the operation of a user's terminal 20, and typically controls the operation of a user's terminal 20 such that the song A is played back on the basis of the break information. For example, the number of times a break unit is played back, or the playback speed for each break unit can be set as control program settings. Here it is supposed that “3 times” has been set as the repetition frequency of a break unit, and “First time 70%, second time 85% and third time 100%” have been set as the playback speeds.

When break information, a control program, and additional information are set as described hereinabove, the training information for the song A is complete. The trainer uploads the completed training information to the server 10 from the terminal 30 (FIG. 1 (1)).

When the server 10 receives the training information, it assigns a training code for specifying the training information. Then, it makes the training code correspondent to a song code previously assigned to the song A and stores it in the management DB. It also makes the training information correspondent to the training code and stores it in the training DB.

Conversely, a user sets a music CD that he purchased at a store in the CD drive of the terminal 20, and copies the data on the music CD to a storage area of the terminal 20 in the MP3 format. Then, the user accesses the server 10 from the terminal 20, and executes a training information search using the song A on the music CD as a keyword (FIG. 1 (2)). When the corresponding training information exists in the server 10, the user can download this information (FIG. 1 (3)). Furthermore, the previously described training information prepared by a trainer is downloaded at this point. When the user downloads the training information, a fee is billed in song units. Further, an amount to be paid to the trainer is calculated in accordance with the download status of training information. The amount paid to the trainer increases the greater the download frequency (FIG. 1 (4)). When the user starts up the training software, the song A is repeatedly played back in accordance with the training information. In other words, first the intro portion of the song A is repeatedly played back three times. In this case, it is played back at 70% speed the first time, 85% speed the second time, and 100% speed the third time. When the playback of the intro part is over, next the first verse is played back in a similar manner, and thereafter, playback is executed similarly for each break unit.

### SERVER CONFIGURATION

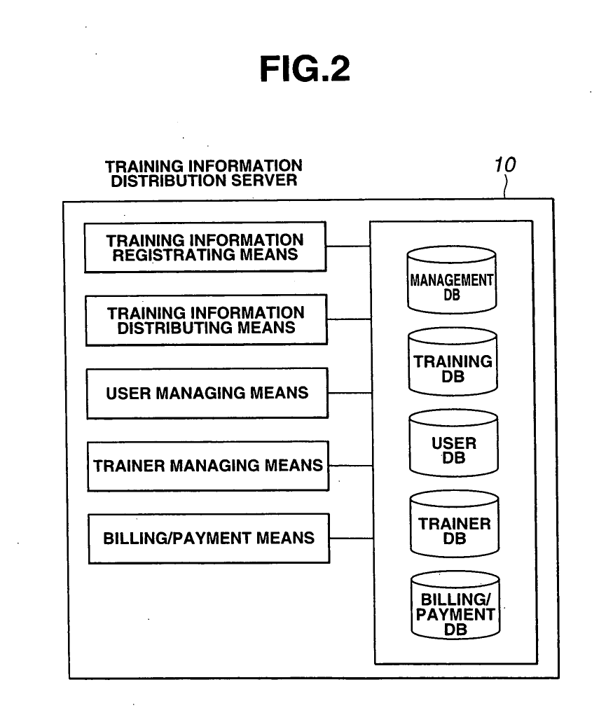

FIG. 2 is a block diagram representing the configuration of the server. The server 10 comprises training information registering means for registering training information in the training DB; training information distributing means for distributing the training information in the training DB; user managing means for managing a user; trainer managing means for managing a trainer; and billing/payment means for managing billing to a user and payment to a trainer in accordance with the distribution of training information. Further, it also comprises the previously described management DB, training DB, user DB, trainer DB, and billing/payment DB.

### USER TERMINAL CONFIGURATION

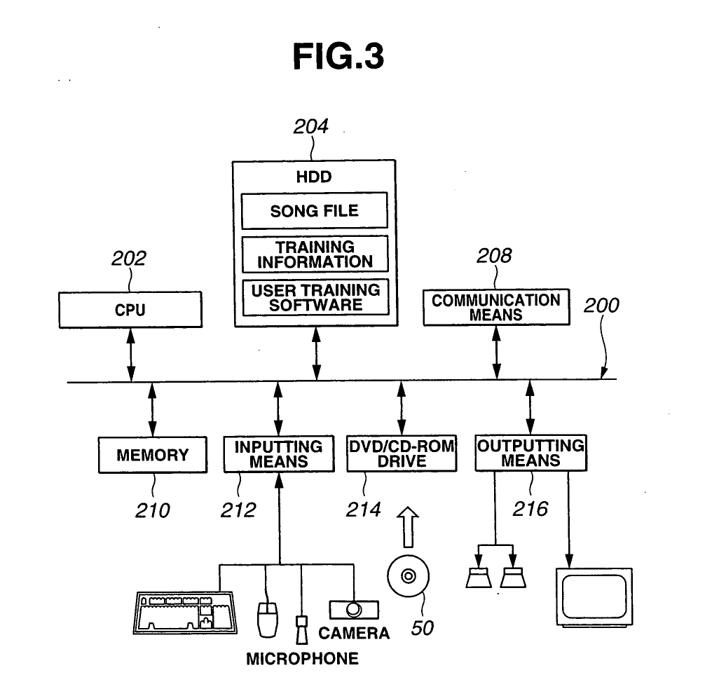

FIG. 3 is a block diagram representing the configuration of a user terminal. In the terminal 20, a CPU 202 for controlling the operation of the terminal 20, an HDD 204, communication means 208, memory 210, inputting means 212, a DVD/CD-ROM drive 214, and outputting means 216 are connected via a bus 200. The terminal 20 corresponds to a general-purpose personal computer. Music data read in from a recording medium (CD-ROM) 50 via the DVD/CD-ROM drive 214 is stored in the HDD 204 as a song file. Further, training information downloaded from the server 10 by way of communications means 204 is also stored in the HDD 204. Further, user training software is stored in the HDD 204 as information processing software for playing back a song file based on training information. Furthermore, music data can also be downloaded via communication means 208 from a prescribed server on a network.

Furthermore, the playback of music data in this embodiment will be explained in terms of music data as song files copied into the HDD 204, but the constitution of the present invention is not limited to this, and can also be applied in cases where music data stored on a recording medium (CD-ROM) 50 is played back directly.

### TRAINER TERMINAL CONFIGURATION

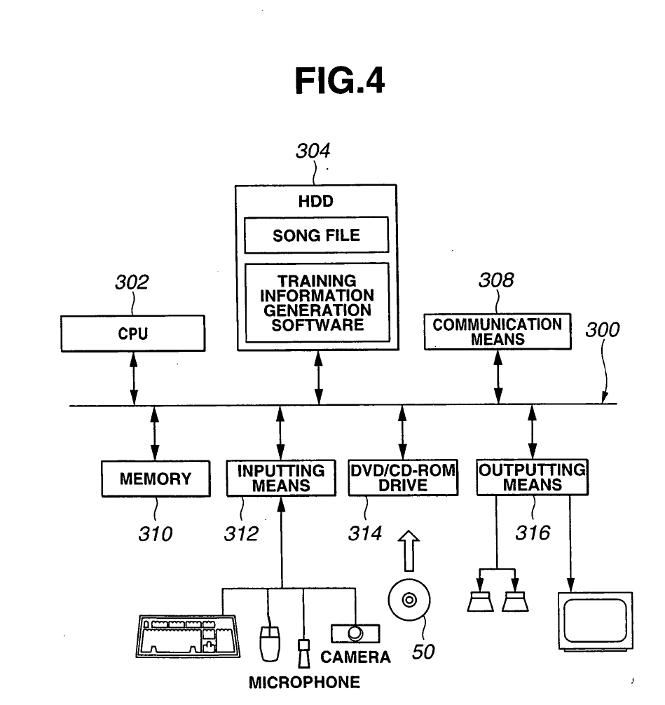

FIG. 4 is a block diagram representing the configuration of a trainer terminal. In the terminal 30, a CPU 302 for controlling the operation of the terminal 30, an HDD 304, communication means 308, memory 310, inputting means 312, a DVD/CD-ROM drive 314, and outputting means 316 are connected via a bus 300. The terminal 30 corresponds to a general-purpose personal computer. Music data read in from a recording medium 50 via the DVD/CD-ROM drive 314 is stored in the HDD 304 as a song file. Further, training program generation software is stored in the HDD 304 as information processing software for generating training information for music.

### DATABASE DATA STRUCTURE

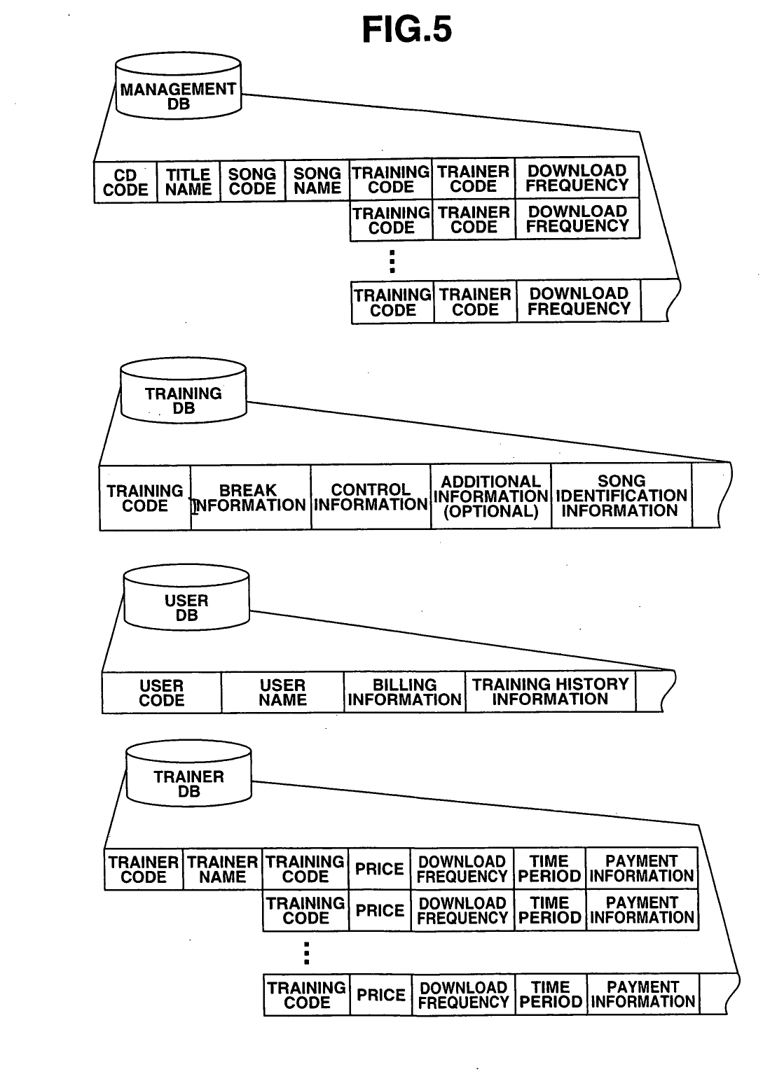

FIG. 5 is a diagram showing an example of database data structures.

The management DB is storage means for managing music information and training information, and is constituted comprising a CD code, title name, song code, song name, training code, trainer code, download frequency and so forth. Each record is uniquely specified by a song code. A code for specifying a music CD is stored in the CD code. A code for specifying a song recorded on a music CD is stored in the song code. A code for specifying training information is stored in the training code. The code of the trainer that generated training information is stored in the trainer code. The number of times training information was downloaded is stored in the download frequency. Further, multiple training information can be generated for a single song, and in that case, multiple training codes are made to correspond to the song code.

The training DB is storage means for storing training information, and is constituted comprising a training code, break information, control information (a control program), additional information, song identification information and so forth. Details of training information will be explained hereinbelow.

The user DB is storage means for storing user-related information, and is constituted comprising a user code, user name, billing information, training history information and so forth. Each record is uniquely specified by a user code.

The trainer DB is storage means for storing trainer-related information, and is constituted comprising a trainer code, trainer name, a training code assigned to training information prepared by a trainer, a price, download frequency, a time period, payment information and so forth. Each record is uniquely specified by a trainer code. Since a trainer can generate a plurality of training information, and when this is the case, data related to a plurality of training information (training codes, prices, and so forth) is linked to the trainer code. Further, trainer-specific training information can also be presented to a user by conducting a search based on a trainer code.

### TRAINING INFORMATION

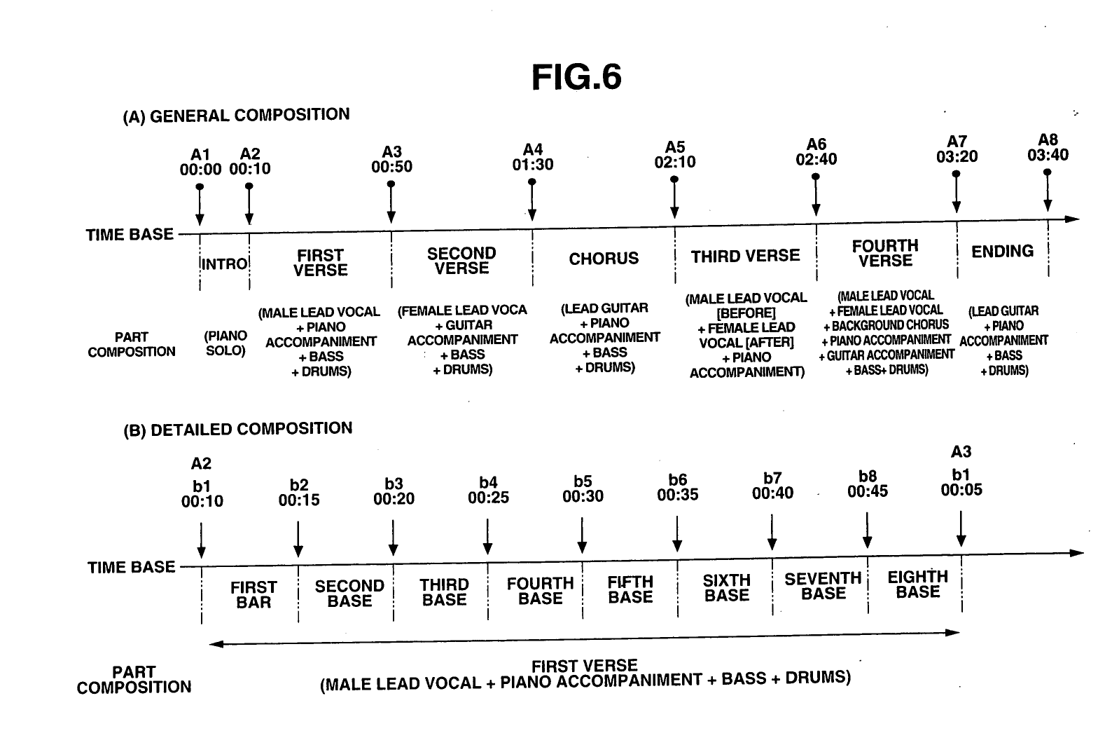

The break information, control program and additional information in training information will be explained here using FIG. 6 through FIG. 8. Furthermore, the song identification information in training information will be explained in the third embodiment. FIG. 6 (A) represents break information (A1 through A8) set as the fundamental units of a piece of music. Further, FIG. 6 (B) represents break information (b1 through b8) set as the bar units of a piece of music. In the case of FIG. 6 (A), repeated playback is done at each of the fundamental units of the “Intro”→“First Verse”→“Second Verse”→“Third Verse”→“Fourth Verse”→“Ending.” By contrast, in the case of FIG. 6 (B), a first verse comprising 12 bars is repeatedly played back as a bar unit. Furthermore, a musical piece is divided in accordance with song playback time, and break information is stored as time information (00:00, 00:10, 00:50 . . . ).

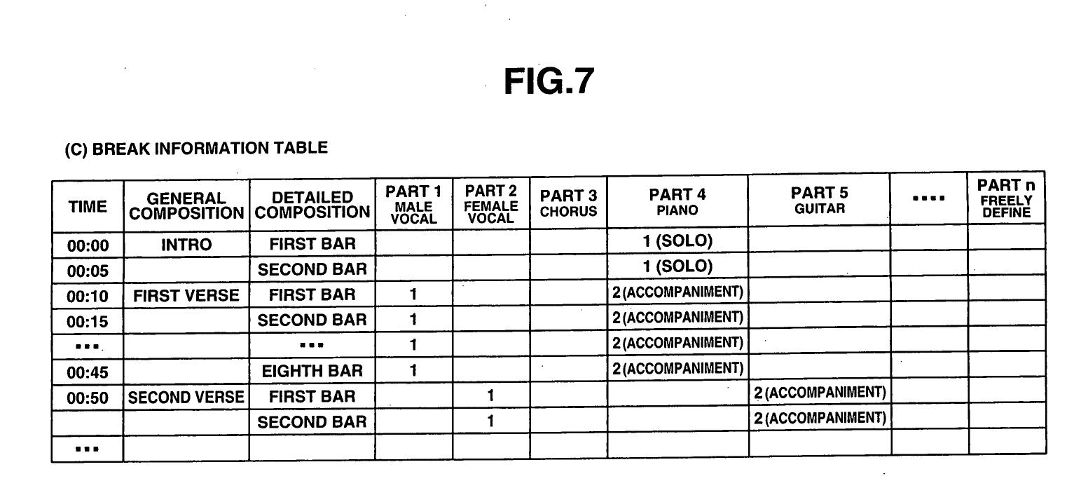

Next, FIG. 7 (C) is a diagram showing an example of a break information table. A break information table is a table for storing time information and attribute information in a correspondent condition. Break information related to this embodiment is constituted from time information for dividing music data along a time base, and attribute information for showing the attributes of music data divided in accordance with time information. A trainer can arbitrarily set the content of attribute information. In FIG. 7, information denoting a general composition and information denoting a detailed composition have been set, and, in addition, information related to the parts for performing a piece of music has been set. Furthermore, it is also possible to set time information alone as break information, but it is preferable that attribute information be set in advance to enable the repetitive playback of music data to be precisely controlled on the basis of time information.

The control program will be explained next. In the control program, it is possible to set not only functions for controlling the playback of music data based on break information, but also various types of functions that enable an original work to be systematically mastered in accordance with a user's goals. The functions of this control program are set premised on the functions of the training software installed on a user terminal 20, and examples of functions capable of being set in a control program will be explained briefly.

(1) A playback function (basic function) for repeatedly playing back music data on the basis of break information.

(2) A playback speed control function for controlling the playback speed of music data.

(3) An automatic modulation function for automatically modulating in an appropriate range in accordance with a user's singing range.

(4) Audio recording function for vocals and instruments.

(5) Song and performance evaluation function (tune, rhythm, pronunciation, and so forth).

(6) A lesson function for carrying out private lessons over the Internet.

(7) A control function for changing the number of repetitions of music data in accordance with scoring results.

(8) A data switching function for switching outputted playback data. In addition, this data switching function, for example, makes it possible to repeat, by break units, “a partial playback of an original foreign song (with lyrics) a reading of a translated version of the lyrics (or a screen display)→a partial karaoke playback (without lyrics: MIDI file).

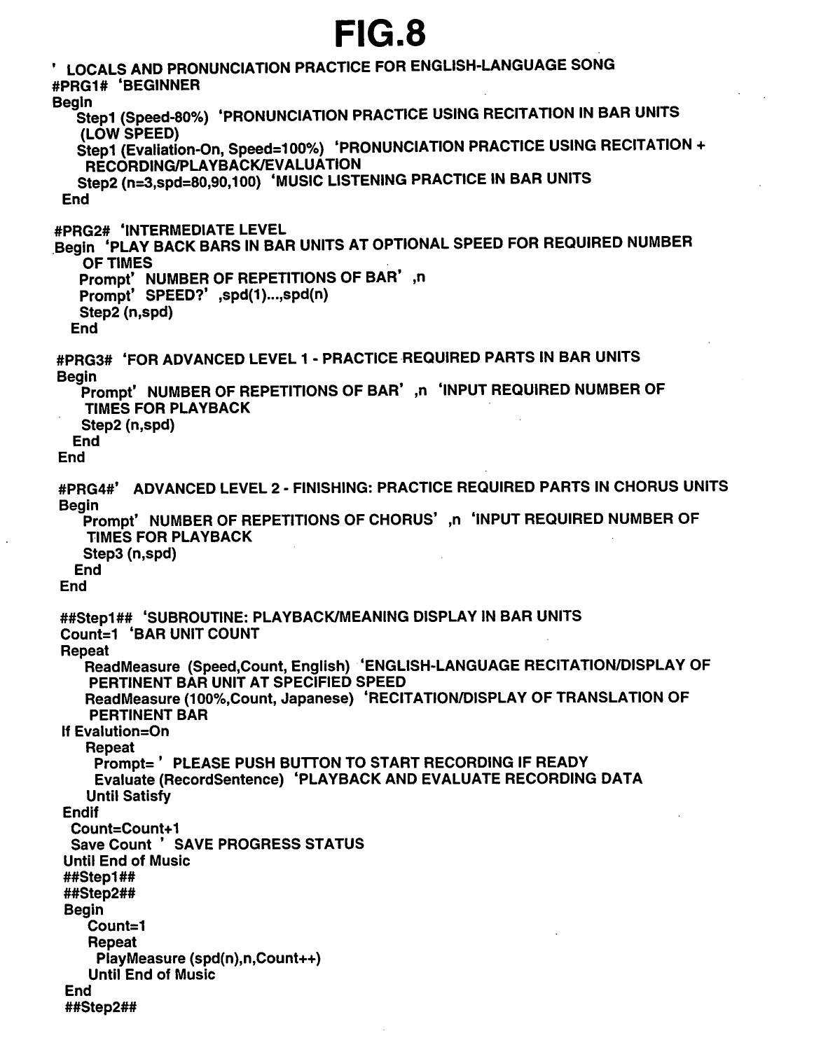

FIG. 8 is a diagram showing examples of control programs. In FIG. 8, four patterns for controlling the playback of music data on the basis of break information are set. The first pattern is content for beginners, and comprises a pronunciation practice routine and a hearing practice routine. For the pronunciation practice routine, a reading speed of 80% is specified, and the recording, playback and evaluation of the user's pronunciation are specified. Further, for the hearing routine, bars are to be repeated three times, and the playback speed is specified so as to be raised from 80% to 90% and up to 100%, in that order. The second pattern is content for intermediate level users, and the settings are such that the user can input the number of repetitions of bars and the playback speed. Further, the third pattern is content for advanced level 1 users, and the settings are such that the user can input the number of repetitions of bars. In addition, the fourth pattern is content for advanced level 2 users, and the settings are such that the user can input the number of repetitions of the chorus. Furthermore, the control program shown in FIG. 8 is only one example, and control program functions can be set according to the circumstances. Accordingly, a trainer can determine whether to set only the music data playback function, or whether to incorporate recording and evaluation functions as well.

### FLOW OF TRAINING INFORMATION GENERATION PROCESSING

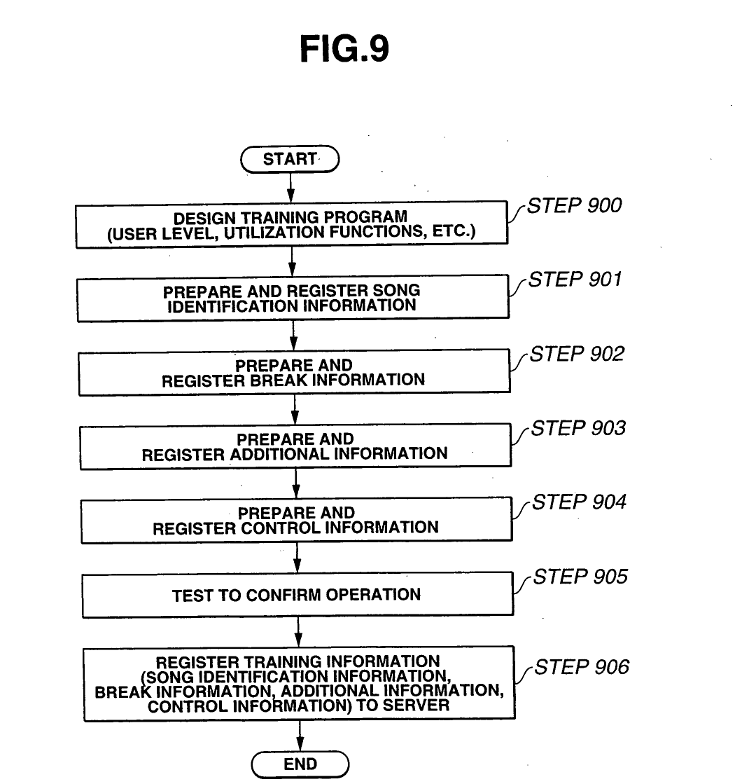

Next, the detailed flow of training information generation processing via a trainer terminal will be explained. FIG. 9 is a flowchart showing the flow of training information generation processing. A trainer terminal 30 designs a training program for a song A based on a trainer's instructions (STEP 900). Next, when the trainer selects a song file for preparing song A training information, the trainer terminal 30 reads out the selected song file from the HDD 304, and generates song identification information. More specifically, the trainer terminal 30 extracts characteristic information from the read-out song file in accordance with a prescribed extraction condition, and generates and registers song identification information comprising the extracted characteristic information and the extraction condition (STEP 901). Furthermore, song identification information will be explained in the third embodiment. Next, break information for the song A is prepared and registered on the basis of trainer instructions (STEP 902), and if the trainer instructs it, additional information is prepared and registered (STEP 903).

When break information and additional information registration is over, the trainer gives break information-based music data playback method instructions and so forth to the trainer terminal 30, and the trainer terminal 30 generates and registers a control program based on the trainer's instructions (STEP 904). Thereafter, when operation confirmation testing is over (STEP 905), the training information for song A is complete. The completed training information is transmitted to the server 10 together with the song code for the song A (STEP 906).

### FLOW OF TRAINING INFORMATION REGISTRATION PROCESSING

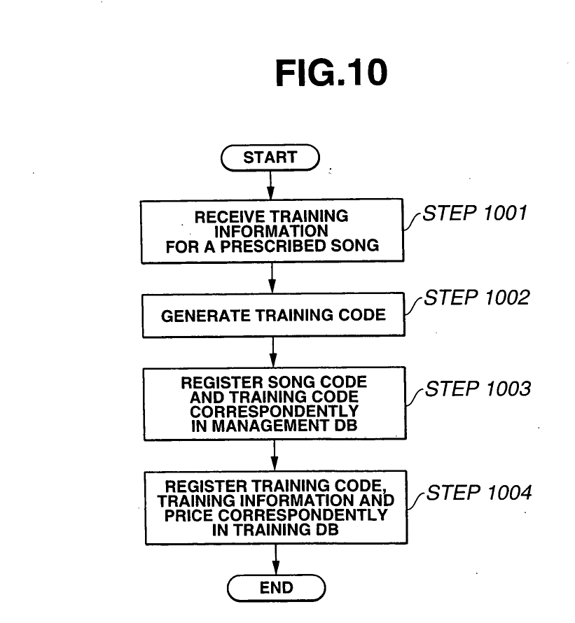

Next, the detailed flow of training information registration processing by the server will be explained. FIG. 10 is a flowchart showing the flow of training information registration processing.

The server 10 receives training information and a song code for the song to which the training information corresponds from the trainer terminal 30 (STEP 1001). The server 10 generates a training code for uniquely specifying the training information, and assigns this code to the training information (STEP 1002). Then, the server 10 correspondently registers the song code and the training code in the management DB (STEP 1003). This makes it possible to search for the training information using the song as the search key. The server 10 correspondently registers the training code, training information and price in the training DB (STEP 1004).

### FLOW OF TRAINING INFORMATION RECEPTION PROCESSING

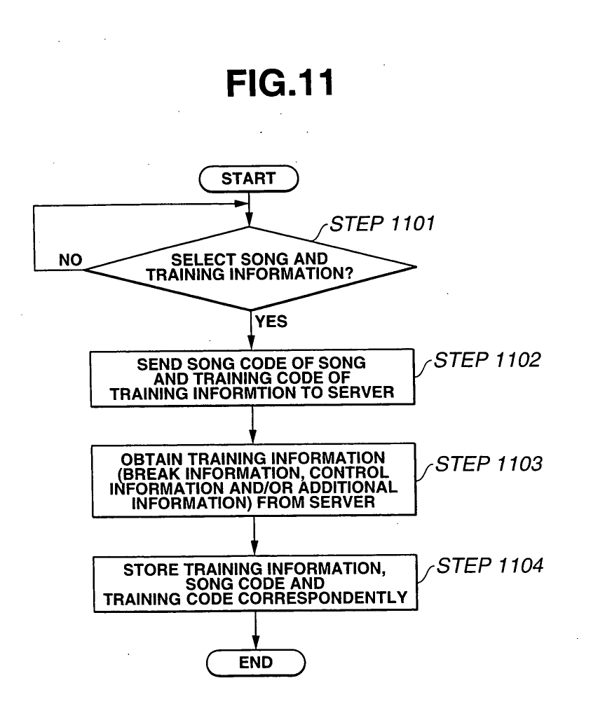

Next, the detailed flow of training information reception processing by a terminal will be explained. FIG. 11 is a flowchart showing the flow of training information reception processing. The user searches for the training information for a desired song via a training information search screen. When the user selects an acquisition condition for a desired song, training information and break information on the training information search screen, and chooses the get data button, the user terminal 20 determines that a song and training information have been selected by the user (STEP 1101; Yes), and transmits the song code of the selected song, the training code of the training information, and the acquisition condition (for example, break information only=A, and break information plus additional information=B) to the server 10 (STEP 1102). Thereafter, when the user terminal 20 receives the training information from the server (STEP 1103), it correspondently stores the training information, training code and song code in a prescribed storage area of the HDD 204 (STEP 1104).

### FLOW OF TRAINING INFORMATION DISTRIBUTION PROCESSING

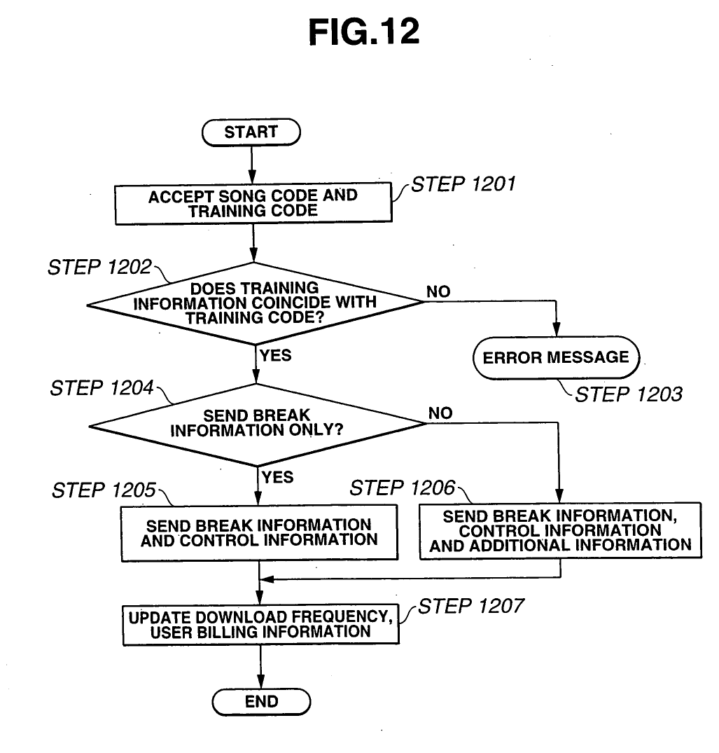

Next, the detailed flow of training information distribution processing by the server will be explained. FIG. 12 is a flowchart showing the flow of training information distribution processing. When the server 10 receives a song code, training code and an acquisition condition from the user terminal 20 (S1201), it searches the management DB in accordance with the received song code and training code (S1202). When relevant training information is registered in the management DB, a determination is made as to whether or not to transmit only break information in accordance with the acquisition condition (S1203).

When the acquisition condition is A, the server 10 makes the determination to transmit only break information, and it transmits break information and a control program corresponding to the training code from the training DB (S1205). By contrast, when the acquisition condition is B, the server 10 makes the determination to transmit break information and additional information, and transmits break information, a control program and additional information corresponding to the training code from the training DB (S1206). When the server 10 transmits the training information, it updates the download frequency of the management DB and the billing information of the user DB (S1207).

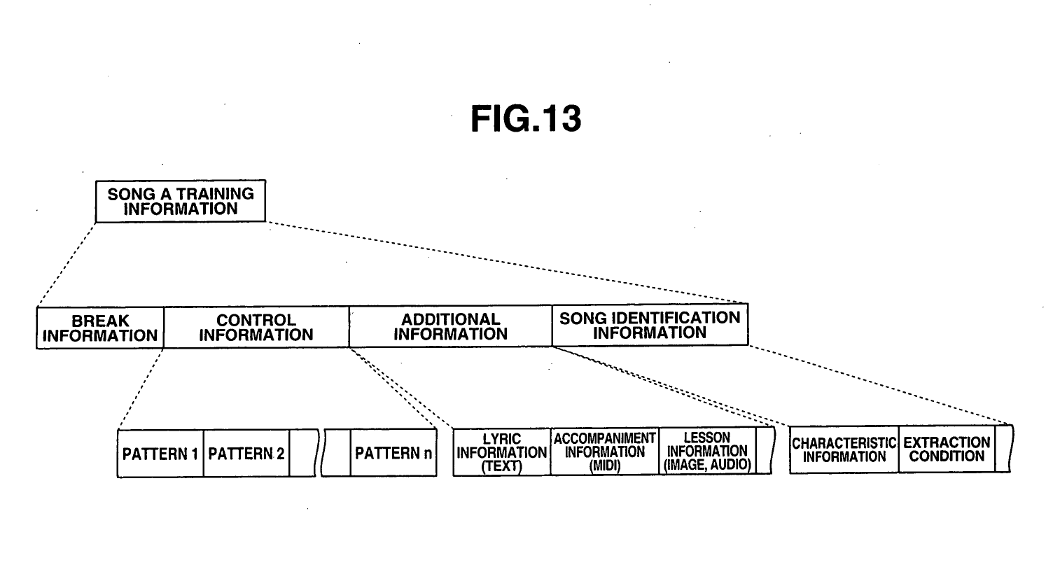

FIG. 13 is a diagram showing examples of training information data structures transmitted via the server 10. The training information of a song A comprises break information, a control program, additional information and song identification information. The control program comprises a plurality of control programs (from pattern 1 to pattern n). Further, additional information includes lyric information comprising a text format, accompaniment information comprising a MIDI format, and lesson information comprising an image format and so forth. Song identification information includes characteristic information of music data, an extraction condition for extracting this characteristic information and so forth. Song identification information will be explained in the third embodiment.

### MUSIC DATA PLAYBACK PROCESSING

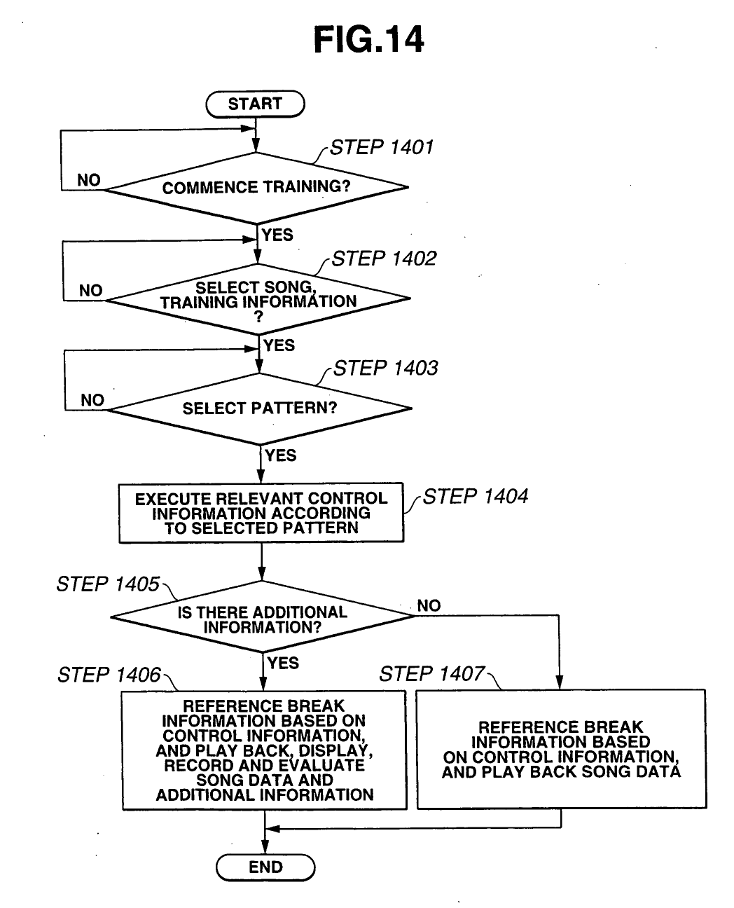

Next, the detailed flow of music data playback processing based on training information will be explained. FIG. 14 is a flowchart showing training information-based music data playback processing.

When training software is started up on a user terminal 20, the CPU 202 displays the training execution screen and waits for the user to input the training start command. When the user inputs the command for commencing training (STEP 1401; Yes), the user terminal 20 displays a list of songs capable of being selected, and prompts the user to select a song that will be used for training, and to select the training information. When the user selects a song and training information (STEP 1402; Yes), the terminal 20 reads out training information corresponding to the song code of the selected song and the training code of the training information from the HDD 204, and prompts the user to select a control program pattern. Furthermore, the constitution can also be such that, when the song and the training information correspond to one another on a one-to-one basis, the song alone is selected.

When the user inputs a pattern selection (STEP 1403; Yes), a control program corresponding to the selected pattern is read in (STEP 1404). Then, when the training information includes additional information, and the user downloads this additional information (STEP 1405; Yes), the user terminal 20 references break information on the basis of the control program, displays music data and additional information, and carries out playback, recording and evaluation output (STEP 1406). Conversely, when training information does not comprise additional information, or when the user does not download additional information (STEP 1405; No), the user terminal 20 references break information on the basis of the control program, and plays back the music data (STEP 1407).

### SCREEN CONFIGURATION

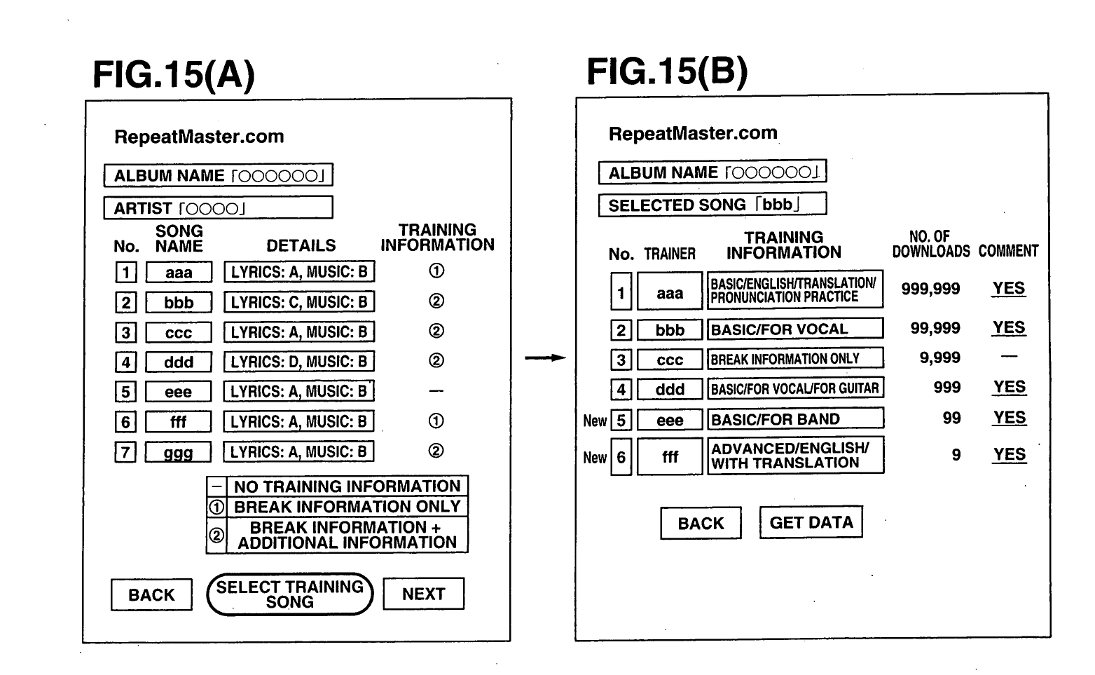

FIG. 15 (A) is a diagram representing an example of a training information search screen (1) displayed on the screen of a user terminal 20. In the training information search screen (1), there are provided areas for displaying song names and detailed information comprising an album specified in advance by a user, and an overview of the training information. In the training information search screen (1), there are also disposed a selection button for selecting a training song, and buttons for specifying movement between screens. When the user selects a desired song, and selects the “Next” button, the screen transitions to the training information search screen (2) shown in FIG. 15 (B).

Training information search screen (2) provides areas for displaying detailed information of the training information for a user-selected song, and a data acquisition button for specifying the downloading of training information. Here, it is clear that a plurality of trainers generated training information for song “bbb.” The user selects the training information that suits him best, and by selecting the “Get Data” button, is able to download the corresponding training information. When the training information downloading is instructed by the user, the user terminal 20 sends a download request comprising the training code and song code of the selected training information.

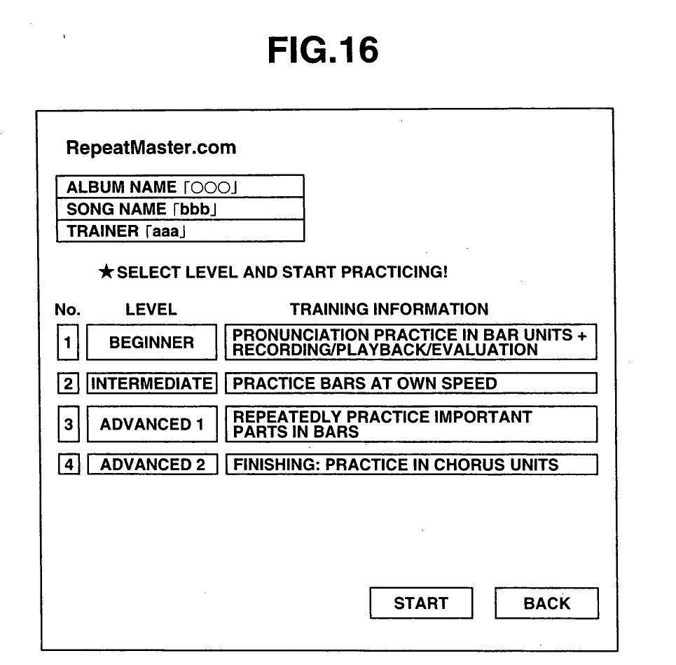

FIG. 16 is a diagram showing an example of a training commencement screen displayed on the screen of a terminal 20. The training commencement screen provides areas for displaying an album name, a song name, and a trainer name, and areas for displaying training levels. Training commences when a user selects the desired level and selects the “Start” button.

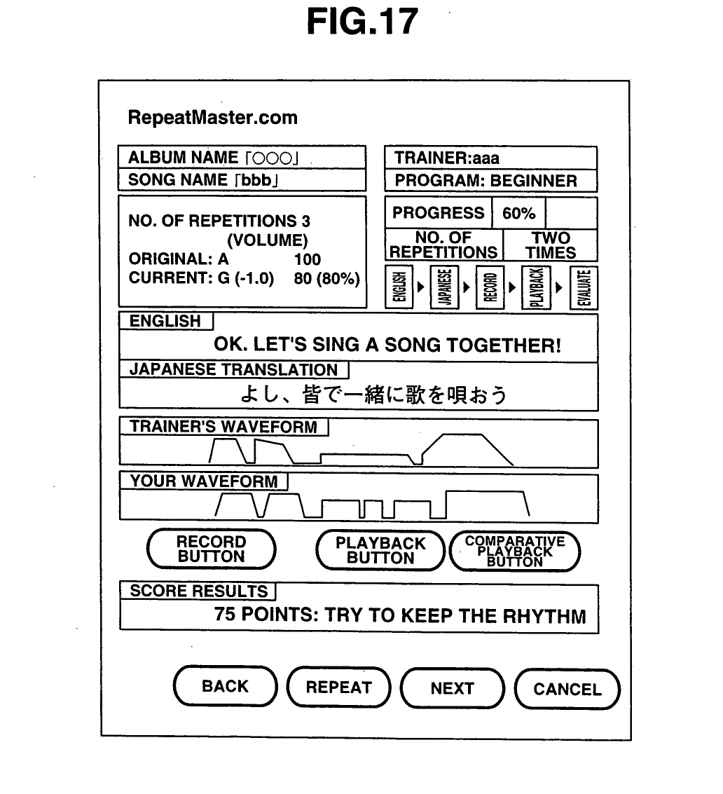

FIG. 17 is a diagram showing an example of a training execution screen displayed on a terminal 20. The training execution screen provides various areas for displaying information corresponding to training execution content. Further, it also provides a variety of buttons for controlling the progress of training. Furthermore, FIG. 17 is a training execution screen for when a user selects a beginner level (pronunciation practice, recording, playback and evaluation in bar units) program. This screen enables a user to compare his waveform with that of the trainer, and also to learn his weaknesses and faults through his scoring results. Further, since a user's progress is also displayed on the screen, it becomes possible for the user to master a piece of music by grasping the state of his lessons.

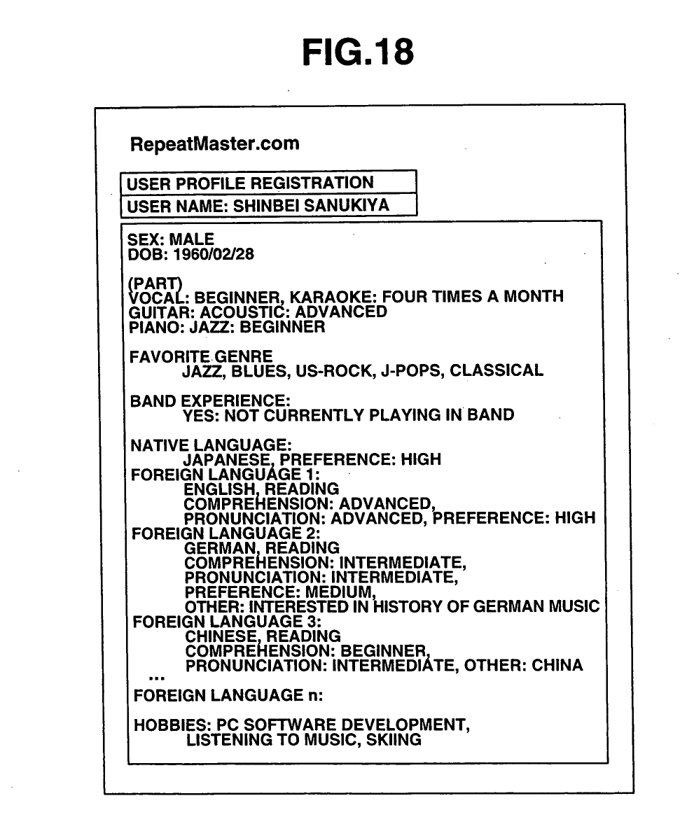

FIG. 18 is a diagram showing an example of a user profile registration screen displayed on the screen of a terminal 20. The user profile registration screen is the screen for registering user information inputted by a user in the terminal 20 as a profile. On the basis of registered user profile information, for example, the terminal 20 can also automatically select and execute a training level. Further, if user profile information is registered in advance in the server, the server 10 can also distribute guidance on the latest training information based on registered user profile information.

### EFFECTS OF THIS EMBODIMENT

According to the above-mentioned embodiment, it becomes possible for a trainer to prepare an original training program based on an existing copyright-protected original work, and for a user to effectively master a purchased original work by using this training program.

Further, by distributing training information (contents) over the Internet, it becomes possible for the trainer business (the education services business) to develop and expand education services without geographical and time constraints, making it possible to provide better services at lower costs as a result.

Further, it is possible to construct an infrastructure for distributing training programs globally via the Internet. This will make it possible to provide a scheme that bridges markets for appreciating original works and markets related to self expression (for example, the karaoke market, concerts, theatrical performances, language learning and the like).

Further, if training programs for learning foreign-language songs are prepared, users will be able to enjoy singing foreign language songs via karaoke without having to know the meaning and grammar of the foreign language.

Furthermore, the explanation given for the above-mentioned embodiment was one in which a trainer prepared the training information, but it is also possible for a user to prepare his own special training information using training information generation software that has been modified for users.

### SECOND EMBODIMENT

A second embodiment is characterized in that training information for an original work (break information, control program, additional information) is recorded on a prescribed recording medium and distributed to users. For the first embodiment, it was explained that the user acquires training information for a desired song from a server. However, there are also situations in which there is no predetermined target song, such as when the object is to learn how to play a prescribed instrument like a guitar or piano without specifying a prescribed song, or when the object is to study a prescribed music genre like jazz or classical music, or when the object is to learn a language like German or Italian, or when the object is to practice a musical piece for an event like a wedding or graduation ceremony.

Accordingly, the second embodiment is constituted such that sample data of songs corresponding to related training information is packaged and distributed to users so as to enable them to effectively learn a piece of music from a variety of angles. Distribution to users can be achieved via a method whereby packaged software, which packages together training information and sample data, is recorded on a prescribed recording medium and this recording medium is distributed, or a method, whereby the packaged software is downloaded to a user terminal 20 over a network. This makes it possible for a user to acquire training information corresponding to his objective, and also enables him to select a musical piece that he will actually practice by listening to the sample data.

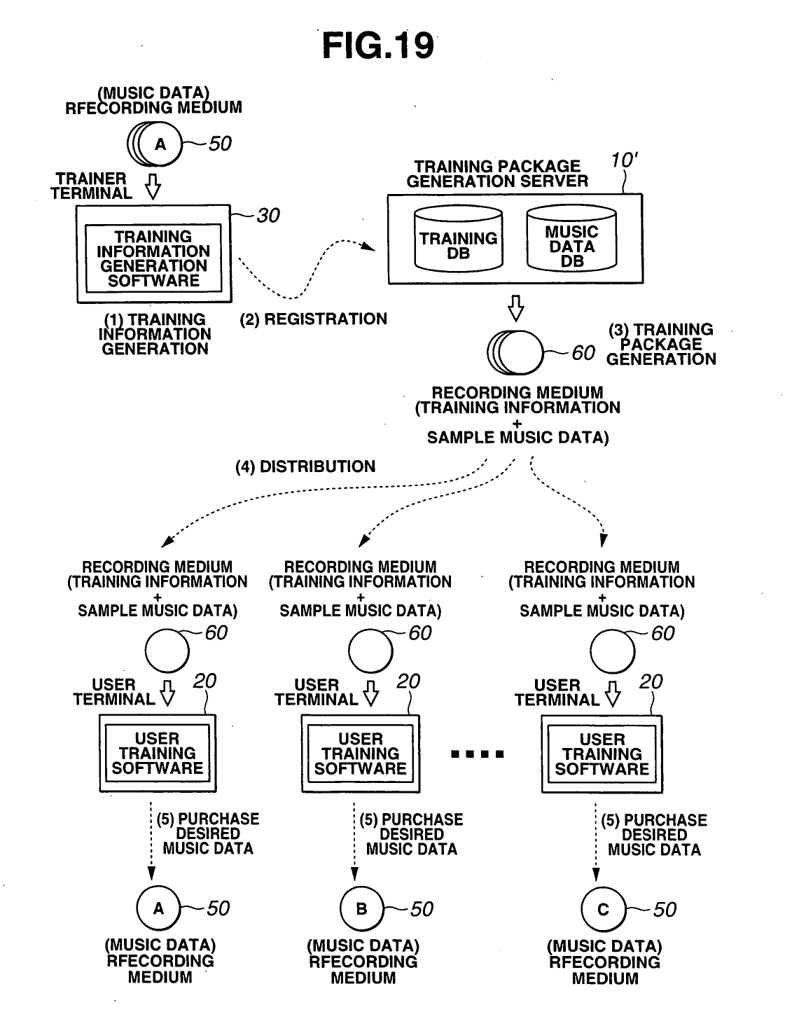

The constitution of a scheme related to the second embodiment will be explained here using FIG. 19. FIG. 19 shows a scheme for recording packaged software, which packages together training information and sample data, on a prescribed recording medium, and distributing this recording medium. In the second embodiment, the server 10′ comprises a training DB for storing training information, and a music DB for storing music data, and generates packaged software that packages together training information and sample music data based on the data in these DBs. Then, the server 10′ generates a for-distribution recording medium for storing this generated packaged software. Furthermore, sample music data signifies data comprising the data of a portion of a song for the purpose of listening to an original work.

First of all, similar to the first embodiment, a trainer prepares training information for a piece of music (FIG. 19 (1)), and registers it in a server 10′ (FIG. 19 (2)). The server 10′ registers the training information in the training DB, and, in addition, associates the training information in accordance with a prescribed condition. The training information, for example, is associated with conditions like “training for Italian-language learning,” or “training for performing at a wedding ceremony.” Further, the server 10′ generates packaged software which associates training information with sample data of the song of the training information. Then, the server 10′ records the generated packaged software on one or a plurality of recording media. Thus, a recording medium 60 on which is recorded packaged software that packages together training information and sample music data is generated (FIG. 19 (3)).

The generated recording medium 60 is distributed to users either for a fee or gratuitously via a prescribed route (FIG. 19 (4)). Various routes can be employed as distribution routes, such as independently via store sales, bundled together with education software, or distributed free of charge as novelty software. A user who obtains a recording medium 60 confirms the list of training information recorded on the recording medium 60, and listens to the sample music data. Then, if the user finds a song that he likes from among the sample music, he can purchase the CD with that song at that time (FIG. 19 (5)). After purchasing the CD, the user can then learn a piece of music based on the training information via the procedure described in the first embodiment.

Furthermore, in a case where the packaged software is downloaded to a user terminal 20 via a network, the present invention can be constituted such that the generated packaged software is distributed to a user terminal 20 over the Internet as shown in FIG. 1.

### THIRD EMBODIMENT

A third embodiment is characterized in that it determines the identity of music data, typically, it determines whether or not the music data (song data) that is to be played back repeatedly on the basis of training information is the same as the music data that the user actually selected.

A user, who purchases a recording medium 50 on which is recorded an original work, can copy the music, that is the music data recorded on this recording medium 50, to the HDD 204 of the terminal 20 in a prescribed file format, and can listen to and/or sing the music by playing it back at his discretion.

With regard to this point, the present invention, as described hereinabove, is constituted such that a user can master an original work more effectively than when he simply plays it back by repeatedly playing back the original work music data in accordance with training information. A user, who purchases a recording medium 50 on which is recorded an original work, copies the music, that is, the music data to the HDD 204, and, in addition, downloads training information corresponding to the music data from the server 10. Then, by running the training software, and respectively selecting the downloaded training information and music data copied to the HDD 204, the music data is repeatedly played back on the terminal 20 in accordance with the training information, and the user can implement training.

However, because a training system like this is constituted such that the user himself selects the music data to be played back, there is the danger that the user will not be able to implement training properly if he selects the wrong music data. It is especially easy for a user to mistakenly select a song file when the user is storing a large amount of music data, that is, song files on the terminal 20, when large numbers of song files with similar song names exist, and when a plurality of versions of the same song exist.

For example, it is supposed that, after selecting training information corresponding to song A, a user selects the music data for song A′ as the data to be repeated. In this case, proper training cannot be implemented because song A′ will be repeatedly played back in accordance with the training information for song A.

Accordingly, this embodiment is constituted so as to determine whether or not the music data of a song file, which a user selects as the playback target, is the music data that corresponds to the training information, thereby preventing the playback of unintended music data.

Further, today a trainer or a user can convert music data recorded on a recording medium 50 to various file formats and store it on HDD 304. PCM, MP3 and WMA are known as typical file formats for storing music data. A trainer or user can create optional digital audio files (song files) for the same music data by selecting such setting conditions as the sampling rate (amount of data per second), bit rate (data size per second), number of channels (stereo, monaural, joint stereo) and sound volume.

Consequently, even if a trainer and user are targeting the same music data, when their respective setting conditions differ, song files with different file formats, file sizes, sound quality and sound volumes are created. Therefore, for example, it is impossible to determine whether or not respective song files were prepared from the same music data by simply comparing the file size of a song file of music data that a trainer targeted when he generated training information against the file size of a song file that a user specified for playback.

Accordingly, this embodiment determines whether or not respective song files were prepared on the basis of the same music data by extracting characteristic information based on a prescribed extraction condition from the music data of the song files to be compared, and comparing this characteristic information. More specifically, characteristic information based on a prescribed extraction condition is extracted from the music data of the song file (for example, an MP3 format) used when the trainer generated training information and the music data of the song file (for example, a WMA format) used when the user implemented training, respectively, and these are compared.

Characteristic information of music data used to generate training information is typically extracted in accordance with a prescribed extraction condition from a trainer-specified song file during training information generation processing as shown in FIG. 9. The extracted characteristic information is included in a portion of the training information as song identification information together with a prescribed extraction condition. Furthermore, the prescribed extraction condition can either be set beforehand in the training information generation software, or can be arbitrarily set by a trainer.

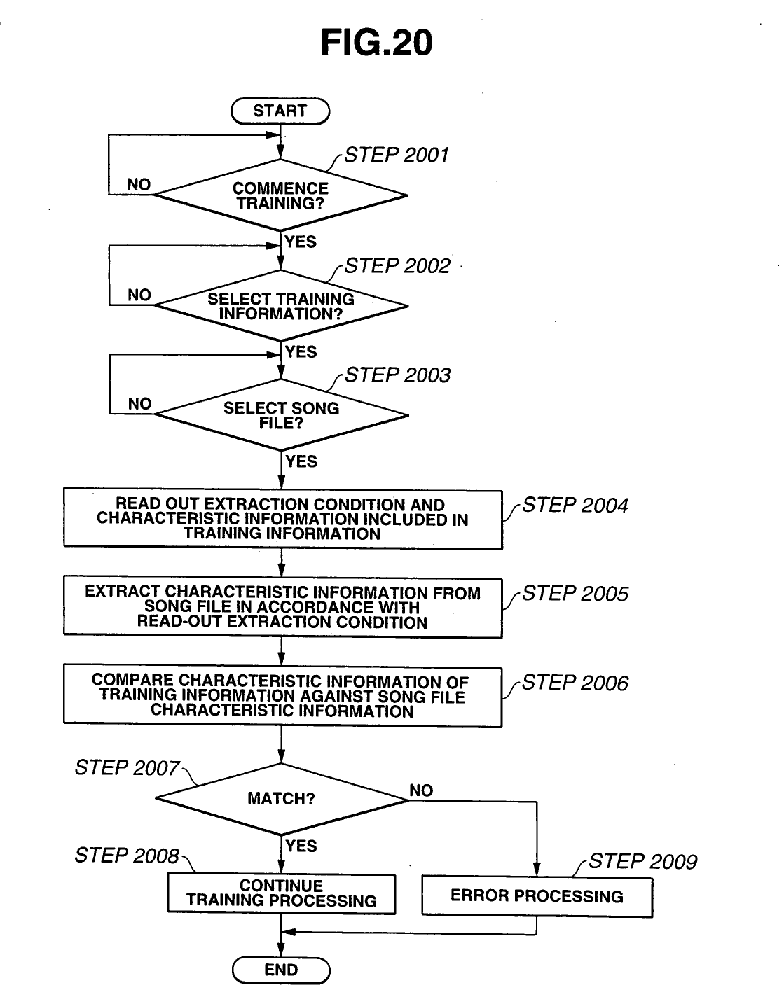

The detailed flow of song data playback processing related to this embodiment will be explained next. FIG. 20 is a flowchart showing song data playback processing related to this embodiment. Furthermore, the premise here is that the user has already used the terminal 20 to download the training information, which comprises, as song identification information, the characteristic information of the music data used to generate training information and the extraction condition by which this characteristic information was extracted.

When a user operates inputting means 212 of the terminal 20 and inputs the command for starting up training software stored in the HDD 204, the CPU 202 reads out the training software from the HDD 204, loads it into memory 210 and executes it. The CPU 202 displays a prescribed training execution screen in accordance with the training software, and waits for the user to input a training commencement command (STEP 2001).

When the command for commencing training is inputted by the user via inputting means 212 (STEP 2001; Yes), the CPU 202 generates a list of songs and training information for enabling user training by referencing the training information in the HDD 204, displays this list on outputting means 216, and prompts the user to select a training song and training information (STEP 2002).

When the user selects a prescribed song and training information via inputting means 212 (STEP 2002; Yes), the CPU 202 temporarily stores the song code of the selected song and the training code of the training information in a prescribed storage area of memory 210. It also generates a list of file names of song files stored in the HDD 204, displays this list on outputting means 216, and prompts the user to select a song file for playback (STEP 2003).

When the user selects a prescribed song file via inputting means 212 (STEP 2003; Yes), the CPU 202 references song identification information comprising the training information of the HDD 204 in accordance with the training code stored in memory 210, and reads out the characteristic information and extraction condition of the song for which the training information was intended (STEP 2004). Next, the CPU 202, in accordance with the read-out extraction condition, executes extraction processing for extracting the characteristic information from the music data of the song file selected for playback (STEP 2005).

When extraction processing is executed, the CPU 202 compares the song characteristic information read out from the training information against the characteristic information extracted from the music data of the song file, and makes a determination as to whether or not the two coincide with one another (STEP 2006). When the CPU 202 determines that the two coincide (STEP 2007; Yes), it continues training processing on the supposition that the music data covered by the training information is the same as the music data of the song file targeted for playback (STEP 2008). More specifically, the CPU 202 executes the pattern selection processing shown in STEP 1403 of FIG. 14.

Conversely, when the CPU 202 determines that the two do not coincide (STEP 2007; No), it continues a prescribed error processing on the supposition that the music data covered by the training information is not the same as the music data of the song file that the user selected (STEP 2009). More specifically, the CPU 202 displays on outputting means 216 a message to the effect that the user-selected song file is not correct, and returns to the song file selection processing of STEP 2003.

Thus, according to this embodiment, since the constitution is such that characteristic information of the music data of the song file specified by the user for playback is compared against the characteristic information of the music data covered by the training information, it becomes possible to prevent the execution of training geared toward the music data of a song file that a user mistakenly selected.

Further, according to this embodiment, it becomes possible to determine whether or not the music data is the same even when the music data used by the trainer and user are in different file formats.

Furthermore, processing for determining whether or not music data coincides by comparing the characteristic information of the music data like this is not limited to training execution time. For example, it can also be applied when a user downloads training information. This is because a user can download desired training information from the training information search screen (Refer to FIG. 15), but if the downloaded training information does not coincide with a user-held song file, the downloaded training information is useless.

More specifically, prior to downloading training information, the server 10 sends the song identification information of the previously selected training information to the user terminal 20. When the user selects desired training information via the training information search screen, the user terminal 20 does not carry out downloading right away, but rather prompts the user to select a song file for training. Once a song file has been selected, the user terminal 20 extracts characteristic information from the selected song file in accordance with the extraction condition included in the previously sent song identification information. Then, it compares the characteristic information contained in the song identification information against the characteristic information extracted from the song file, and determines whether or not the two coincide. When the two coincide, it downloads the selected training information, and when the two do not coincide, it outputs a message to the effect that the user song file does not correspond to the training information.

Accordingly, a user can find out if the song file he has coincides with training information before downloading the training information. Thus, it becomes possible to prevent a situation in which downloaded training information cannot be executed.

Further, processing for comparing the characteristic information of music data can also be used to retrieve training information. For example, there are instances when a user will want to retrieve training information that corresponds to music (a song file) that he has. In a case like this, characteristic information is extracted from the music data of the user-selected song file, and a search request comprising this characteristic information is sent to the server 10. The server 10 searches the training DB in accordance with the characteristic information in the sent search request, acquires from the training DB training information having characteristic information that coincides with the characteristic information in the search request, and returns a list of the training information to the user terminal 20.

Accordingly, since it becomes possible for a user to easily and quickly retrieve training information corresponding to music (a song file) that he possesses, user convenience is enhanced.

Furthermore, besides the music data copied to the HDD 204, a user can also select for direct playback music data recorded on a recording medium 50. In this case, the user selects for playback a song recorded on a recording medium 50 by inserting the recording medium 50 into the DVD/CD-ROM drive 214.

### OTHER EMBODIMENTS

The above-mentioned embodiments are examples used to explain the present invention, and the present invention is not purported to be limited to only these embodiments. The present invention can be put into practice in a variety of aspects without departing from the spirit thereof. Further, in the above-mentioned flowcharts, reception processing for request messages was explained sequentially, but the present invention can also be constituted such that the processing order is either switched or carried out in parallel without causing discrepancies in operation.

For example, it is also possible to constitute the present invention such that a list of training information is presented to a user, and when the user selects desired training information, the training information is bundled together with music data and provided to the user. This will be briefly explained hereinbelow.

A server holds training information and song data corresponding to training information in readiness. Then, in response to a user request, the server sends a list of providable training information to the user terminal. The user selects desired training information from the list of training information, and if he does not have the song for that training information, he can choose to download song data. When the user selects the downloading of training information and song data, the server sends the selected training information and song data to the user terminal.

According to the above-mentioned embodiment, since a user can simultaneously acquire training information and music data when he wants to sing a certain song, it becomes possible to purchase training information and music as the need arises. It also becomes possible for record/CD businesses that sell music to acquire a new marketing route by selling music bundled with training information. In addition, according to the above-mentioned embodiment, it also becomes possible to link users to record/CD businesses via a new scheme that calls for providing an original work and training information intended for this original work.

According to the present invention, it becomes possible for a user to effectively learn an original work.

1. A training system comprising a user terminal for executing training for user skill acquisition by using music data of an original work; a trainer terminal for generating training information for user skill acquisition; and a server for carrying out communications with the user terminal and the trainer terminal over a network, wherein:
the trainer terminal comprises:
generating means for generating, based on trainer instructions, training information related to the original work music data; and
transmitting means for transmitting generated training information to the server,
the server comprises:
distributing means for distributing received training information to the user terminal, and
the user terminal comprises:
playback means for repeatedly playing back the original work music data based on distributed training information.

2. The training system according to claim 1, characterized in that said generated training information includes break information for showing arbitrary breaks in music data, and
said user terminal playback means specifies parts to be played back in the music data on the basis of the break information included in distributed training information, and repeatedly plays back the specified parts.

3. The system according to claim 1, characterized in that said generated training information includes a control program for controlling the playback of music data on the basis of break information, and
said user terminal playback means references the break information in accordance with the control program included in distributed training information, and repeatedly plays back the music data.

4. The training system according to claim 1, characterized in that said generated training information includes additional information to be played back in association with music data, and
said user terminal further comprises outputting means for outputting the additional information in association with music data in accordance with a control program included in distributed training information.

5. The training system according to claim 1, characterized in that said generated training information includes characteristic information of said music data, which is extracted in accordance with a prescribed extraction condition from music data corresponding to the training information, and
said user terminal further comprises determination means for extracting, from music data intended for playback, characteristic information of the music data in accordance with said prescribed extraction condition, and determining whether or not this extracted characteristic information coincides with characteristic information included in distributed training information.

6. The training system according to claim 1 characterized in that said server further comprises calculation means for calculating, in accordance with the distribution status of training information, an amount to be billed to a user and an amount to be paid to a trainer.

7. A training method based on a training system comprising a user terminal for executing training for user skill acquisition by using music data of an original work; a trainer terminal for generating training information for user skill acquisition; and a server for carrying out communications with the user terminal and the trainer terminal over a network, wherein:
said trainer terminal generates, based on trainer instructions, training information related to music data of an original work, and transmitting this generated training information to the server;
said server distributes received training information to the user terminal; and
said user terminal repeatedly plays back the original work music data based on the distributed training information.

8. The system according to claim 2, characterized in that said generated training information includes a control program for controlling the playback of music data on the basis of break information, and
said user terminal playback means references the break information in accordance with the control program included in distributed training information, and repeatedly plays back the music data.

9. The training system according to claim 2, characterized in that said generated training information includes additional information to be played back in association with music data, and
said user terminal further comprises outputting means for outputting the additional information in association with music data in accordance with a control program included in distributed training information.

10. The training system according to claim 3, characterized in that said generated training information includes additional information to be played back in association with music data, and
said user terminal further comprises outputting means for outputting the additional information in association with music data in accordance with a control program included in distributed training information.

11. The training system according to claim 2, characterized in that said generated training information includes characteristic information of said music data, which is extracted in accordance with a prescribed extraction condition from music data corresponding to the training information, and
said user terminal further comprises determination means for extracting, from music data intended for playback, characteristic information of the music data in accordance with said prescribed extraction condition, and determining whether or not this extracted characteristic information coincides with characteristic information included in distributed training information.

12. The training system according to claim 3, characterized in that said generated training information includes characteristic information of said music data, which is extracted in accordance with a prescribed extraction condition from music data corresponding to the training information, and
said user terminal further comprises determination means for extracting, from music data intended for playback, characteristic information of the music data in accordance with said prescribed extraction condition, and determining whether or not this extracted characteristic information coincides with characteristic information included in distributed training information.

13. The training system according to claim 4, characterized in that said generated training information includes characteristic information of said music data, which is extracted in accordance with a prescribed extraction condition from music data corresponding to the training information, and
said user terminal further comprises determination means for extracting, from music data intended for playback, characteristic information of the music data in accordance with said prescribed extraction condition, and determining whether or not this extracted characteristic information coincides with characteristic information included in distributed training information.
